(19) United States
(12) Patent Application Publication
(10) Pub. No.: US 2012/0203694 A1
(43) Pub. Date: Aug. 9, 2012

(54) PROCEDURE FOR THE JOINT CANCELLATION OF DEBTS OF SEVERAL ENTITIES

(75) Inventor: Gabino Brito Garcia, Madrid (ES)

(73) Assignee: Excancel Euro S.L., Madrid (ES)

(21) Appl. No.: 13/502,452

(22) PCT Filed: Oct. 23, 2009
(86) PCT No.: PCT/ES2009/000510

§ 371 Date: Apr. 17, 2012

(51) Int. Cl. G06Q 20/08

(52) U.S. Cl. 705/40

(57) ABSTRACT

Procedure for the settlement of debts between two or more users registered in a server through an open network, which encompasses three phases; such as validation of the user, where the server sends an e-mail to the user, who confirms the registration from his/her account. Then there is validation of debts by the user, who enters the personal details and identification numbers of other debtors or creditors together with the amount requested on the website of the server. Subsequently, the server sends the debtor the request and the debtor confirms the debt and enters an accepted amount from a personal computer. Finally, the server stores the data of the debt with the lower of the amounts requested or accepted. Also, there may be transactions of debts, whose calculation is based on the creation of PERT graphs with a number of users and debts. The server stores the cancelled debts and creates debt cancellation certification documents.

### TECHNICAL FIELD

The present invention fits within the technology sector on games and especially the processing of data within the area of calculation and computation.

### STATE OF THE ART

At present, the state of the art only includes systems to cancel debts between banking entities based on the transactions which the clients of each entity make with the other entities with which a banking entity wishes to clear its debts. These are closed systems, only for banking entities, based on the Bank Clearing House. Similar procedures exist in other countries and they are also carried out at an international level.

On the other hand, different methods are known in the state of the art in which internet users can access virtual environments in a secure manner through key words and verifications of information.

However, within the state of the art, no procedure or system is known which serves to settle debts between private individuals based on technical elements which offer users security, flexibility and consistency.

### EXPLANATION OF THE INVENTION

This invention aims to provide a system and a procedure based on computer tools for the settlement of debts between private individuals and/or companies. For this, the object of this invention is to create a system which helps companies and individuals to settle their due debts, both to pay and to collect, without having to pay any money.

The procedure consists of a computer system for the transmission of information which includes a device to authenticate the information and this procedure consists on the following phases:
To set a Web page where firms introduce their debts.
The system will aim to seek combinations between users' commercial debts so that the payment of the debt is effected with the collection of another.
The more firms enter debts, the more effective will be the system
Any debt which is accepted by both parties can enter the system.

### BRIEF DESCRIPTION OF THE DRAWINGS

FIG. 1 shows the general structure of the procedure.

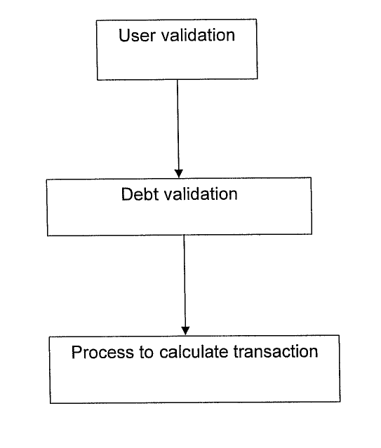

FIG. 2 is a diagram of the user validation.

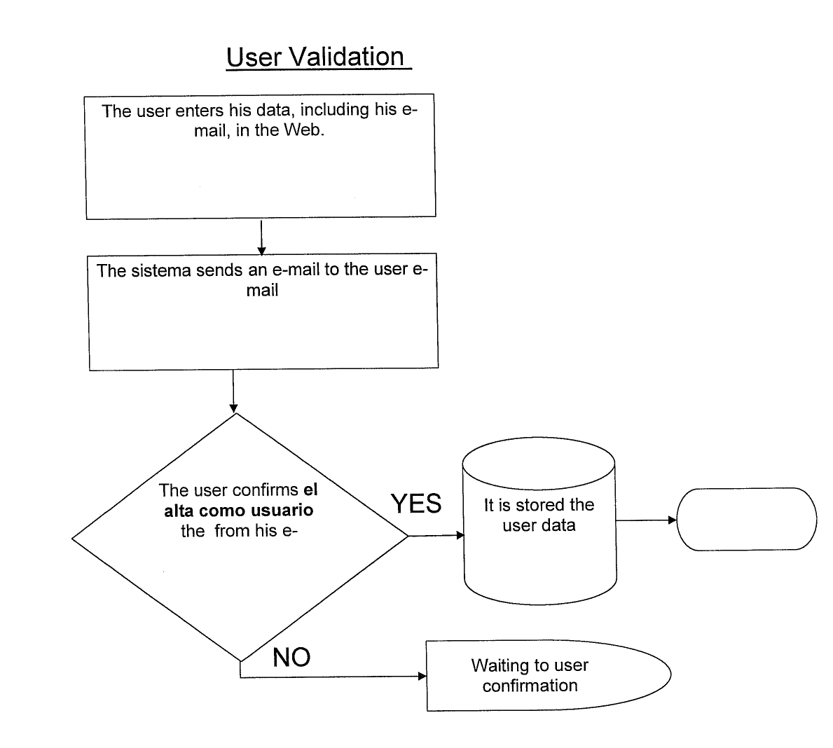

FIG. 3 is a diagram of the validation of debts.

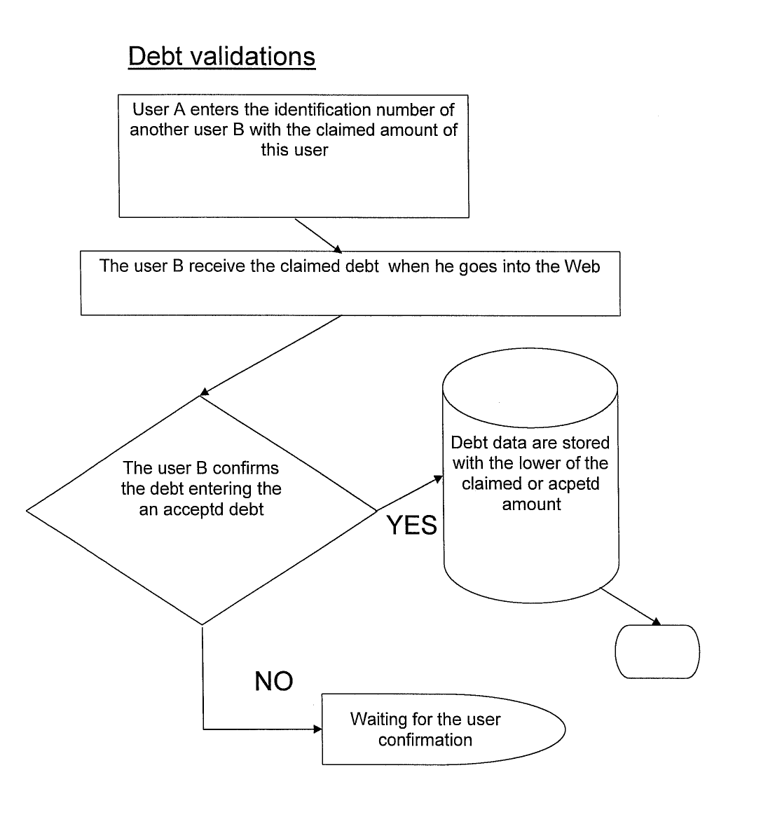

FIG. 4 is a diagram of the calculation of transactions.

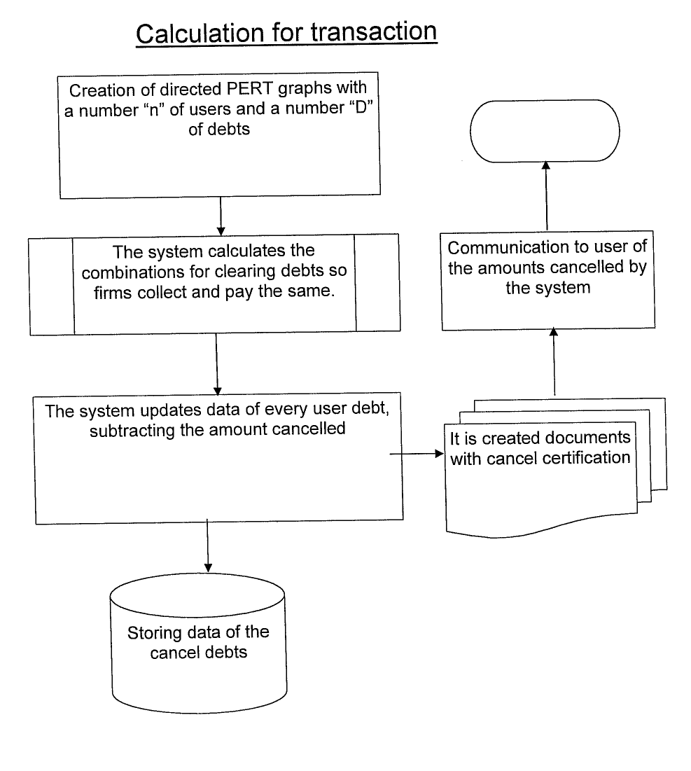

### INDUSTRIAL APPLICATION

This invention has an industrial application in the sector of technology related to information processing.

1-2. (canceled)

3. Procedure for the settlement of non-matured debts between two or more users through an open network, in particular the INTERNET, comprising the following three phases:
validation of the user, in which the user accesses a web page located on a server from a personal computer by means of a validation via e-mail,
validation of the debts by the user by entering their own personal data and those of the debtors or creditors on the web page of the system housed on the server,
transactions of debts between those registered characterised because once the user has registered on the website, the validation phase encompasses the following stages:
sending of an e-mail from the server to the user, with information about the validation,
sending of a confirmation e-mail by the user,
confirmation of registration in the debt settlement system from the user's e-mail account and because the debt validation phase is characterised because it encompasses the following phases:
entry of the identification number of other debtors together with the amount requested by the user,
receipt of the debt payment request by the debtor through the web page set up by the server,
confirmation by the debtor of the debt and entry of an accepted amount from their personal computer,
storage in the server of the data of the debt with the lower of the amounts requested or accepted and because the phase of calculation of transactions is characterised by the fact that the server stores the data of the cancelled debts and sends debt cancellation certification documents via email, with the amount cancelled, and because the transactions of debts between those registered is based on the creation of a directed PERT graph based on a number “N” of users and a number “D” of debts in which the system calculates the combinations of cancellation in such a way that all the companies collect and pay the same and the system updates the data of the debts of all the users, deducting the amounts cancelled, and creates debt cancellation certification documents with the amount cancelled.
